(19) United States
(12) Patent Application Publication
(10) Pub. No.: US 2010/0209636 A1
(43) Pub. Date: Aug. 19, 2010

(54) POLYLACTIDE-COATED PAPERBOARD

(75) Inventors: Wen-Jen LAI, Taipei City (TW); Chih-Hsien HUANG, Taipei City (TW)

Correspondence Address: BRIAN M. MCINNIS, 12th Floor, Ruttonjee House, 11 Duddell Street, Hong Kong, HK

(73) Assignee: WEI MON INDUSTRY CO., LTD., HSINCHU COUNTY (TW)

(21) Appl. No.: 12/553,990

(22) Filed: Sep. 4, 2009

(30) Foreign Application Priority Data
Feb. 16, 2009 (TW) 98104860

(51) Int. Cl. B32B 1/02; B32B 27/10

(52) U.S. Cl. 428/34.2; 428/481

(57) ABSTRACT

A polylactide-coated paperboard is provided. The polylactide-coated paperboard includes a paperboard and at least one polylactide layer on the paperboard. The polylactide layer is made from a compound that contains 97-100 wt % polylactic acid.

### RELATED APPLICATIONS

This application claims priority to Taiwan Application Serial Number 98104860, filed Feb. 16, 2009, which is herein incorporated by reference.

### BACKGROUND

1. Technical Field

The present disclosure relates to a paperboard. More particularly, the present disclosure relates to a biodegradable paperboard.

2. Description of Related Art

Based on the considerations of the cost and the mass-production of a is food container, a conventional food container, such as a cup, a bowl or a plate, is made of paperboard coated internally with a plastic film to ensure the container is both water-resistant and oil-resistant. The plastic film is made from polyethylene terephthalate (PET), polyvinyl alcohol (PVA), ethylene vinyl acetate (EVA), or low-density polyethylene (LDPE).

However, people are becoming increasingly concerned with the environment. The foregoing conventional food container cannot be broken down after it is discarded. Although incineration is used to deal with the foregoing conventional food container, a lot of gases are produced during the incineration process. Therefore, the foregoing food container is a big source of pollution once discarded.

### SUMMARY

A polylactide-coated paperboard is provided. The polylactide-coated paperboard includes a paperboard and at least one polylactide layer on the paperboard. The polylactide layer is made from a composition containing 97-100 wt % polylactic acid.

A food container is provided. The food container includes the foregoing polylactide-coated paperboard.

### BRIEF DESCRIPTION OF THE DRAWINGS

The disclosure can be more fully understood by reading the following detailed description of the embodiment, with reference made to the accompanying drawings as follows:

FIG. 1 is a polylactide-coated paperboard according to one embodiment of this disclosure; and

FIG. 2 is a polylactide-coated paperboard according to another embodiment of this disclosure.

### DETAILED DESCRIPTION

Several biodegradable materials have replaced the plastic material and are now coated on the paperboard. The biodegradable materials are polylactic acid, starch, or polycaprolactone (PCL). The conventional food container or paperboard is coated with a biodegradable film made from a solution containing more than 50 wt % polylactic acid. However, the most biodegradable films coated on the food container still contain some non-biodegradable materials. These non-biodegradable materials are still retained in the environment and become a source of pollution, and the pollution problem of the environment is not completely solved.

Accordingly, a polylactide-coated paperboard is provided in an embodiment of the present disclosure. The polylactide layer made from a composition containing a very high content of polylactic acid is coated on a paperboard to form the polylactide-coated paperboard.

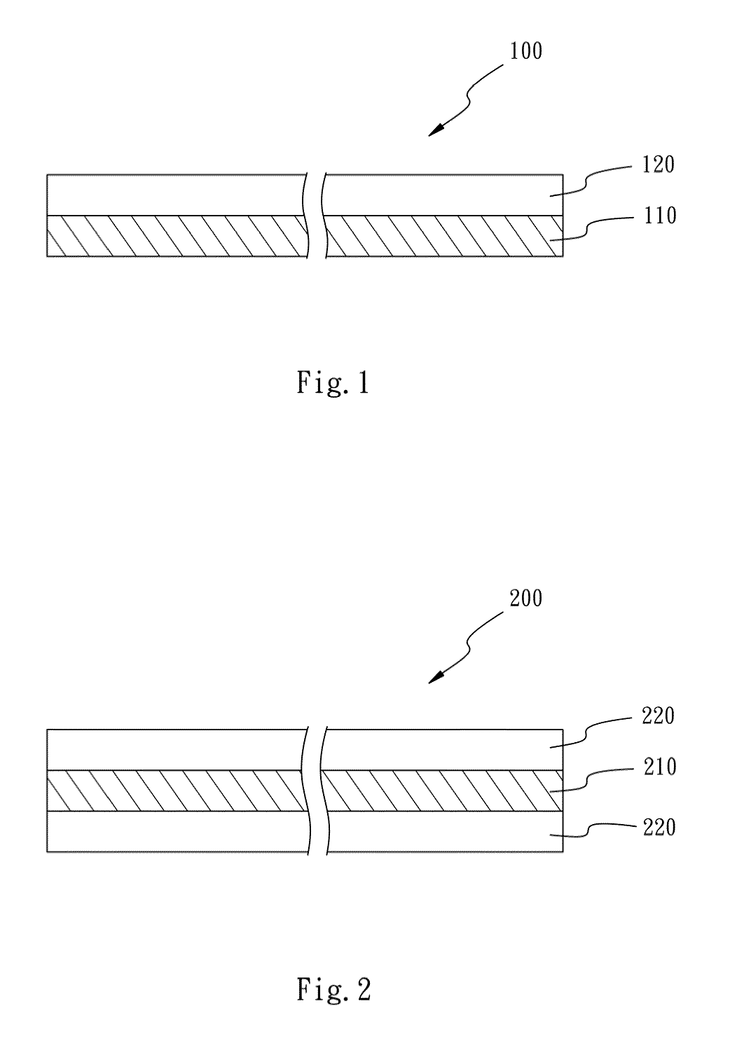

FIG. 1 is a polylactide-coated paperboard according to one embodiment of this disclosure. The polylactide-coated paperboard 100 includes a paperboard 110 and a polylactide layer 120 on the paperboard 110. The polylactide layer 120 is made from a compostion that contains 97-100 wt % polylactic acid. The polylactic acid composition is directly extruded and coated on the paperboard 110 to form the polylactide layer 120. Alternatively, a polylactide film is made from the polylactic acid compositon and than stuck on the paperboard 110 to form the polylactide layer 120.

The rigidity of the polylactide layer is greater than the conventional plastic layer, so the paperboard coated by the polylactide layer can be thinner than paperboard coated by the conventional plastic layer. In other words, the weight of the paperboard coated by the polylactide layer is lighter. Furthermore, the thermal energy produced by the polylactide-coated paperboard during incineration is less than that produced by the conventional plastic materials.

In addition, according to different product application, the content of polylactic acid compostion is adjustable. For example, starch, PCL, or polyol can be added into the polylactic acid compostion. The starch, PCL, or polyol in the polylactic acid compostion is less than 3 wt %. For example, when a polylactide-coated paperboard is folded to be a box or a specific form, the starch, PCL, or polyol can be mixed with polylactic acid to increase the softness of the polylactide layer.

In addition to single side of the paperboard is coated with the polylactide layer above, the polylactide layer also can be coated on the each side of the paperboard. FIG. 2 is a polylactide-coated paperboard according to another embodiment of this disclosure. In this embodiment, a polylactide-coated paperboard 200 includes a paperboard 210 and two polylactide layers 220 respectively on each surface of the paperboard 200. Alternatively, more than one polylactide layer 220 can also be coated on each surface of the paperboard 210. Therefore, both surface of the paperboard 210 has coated with polylactide layer and is waterproof.

The foregoing polylactide-coated paperboard is used to manufacture various food containers, such as cups, plates or bowls. The disintegration of a polylactide-coated paperboard containing a polylactide layer made from a 100 wt % polylactic acid is tested under an artificial compost environment. The temperature range of the artificial compost environment is at 56-60° C., and the air in the artificial compost environment contains the saturated water but without CO₂. The disintegration of the polylactide-coated paperboard is shown in Table 1.

TABLE 1

| | Content of |
|---|---|
| | Polylactide |
| | layer |
| | 100 wt % |
| DAYS | Polylactide |
| DAY 5 | 1.07 wt % |
| DAY 10 | 3.64 wt % |
| DAY 20 | 17.84 wt % |
| DAY 30 | 54.42 wt % |
| DAY 40 | 61.86 wt % |
| DAY 80 | 91.43 wt % |
| DAY 88 | 95.37 wt % |

As shown in Table 1, more than 50 wt % of the 100% polylactide-coated paperboard is decomposed under the artificial compost environment for 30 days. When the polylactide-coated paperboard is put in the artificial compost environment over 80 days, more than 90 wt % of the polylactide-coated paperboard is decomposed. Accordingly, the polylactide-coated paperboard can be almost totally decomposed in the artificial compost environment.

What is claimed is:

1. A polylactide-coated paperboard comprising:
a paperboard; and
at least a polylactide layer on the paperboard, the polylactide layer made from a composition that contains 97-100 wt % polylactic acid.

2. The polylactide-coated paperboard of claim 1, wherein a plurality of polylactide layers on each surface of the paperboard.

3. The polylactide-coated paperboard of claim 1, wherein the composition contains 98 wt %, 99 wt % or 100 wt % polylactic acid.

4. The polylactide-coated paperboard of claim 1, wherein the composition contains starch, polycaprolactone or polyol.

5. A food container comprising the polylactide-coated paperboard of claim 1.

6. The food container of claim 5, wherein the polylactide layer of the polylactide-coated paperboard is made from a composition that contains 98 wt %, 99 wt % or 100 wt % polylactic acid.

7. A polylactide-coated paperboard comprising:
a paperboard; and
at least a polylactide layer on the paperboard, the polylactide layer made from a 100 wt % polylactic acid.

8. The polylactide-coated paperboard of claim 7, wherein a plurality of polylactide layers on both surfaces of the paperboard.
